(19) United States
(12) Patent Application Publication
(10) Pub. No.: US 2012/0163642 A1
(43) Pub. Date: Jun. 28, 2012

(54) ADVANCED MICROPHONE PROTECTION

(75) Inventors: Erich Dittli, Reichenburg (CH); Axel Schlesinger, Stafa (CH)

(73) Assignee: PHONAK AG, Stafa (CH)

(21) Appl. No.: 13/394,367

(22) PCT Filed: Sep. 7, 2009
(86) PCT No.: PCT/EP09/61566

§ 371 Date: Mar. 6, 2012

(51) Int. Cl. H04R 25/00

(52) U.S. Cl. 381/322

(57) ABSTRACT

A hearing aid housing comprises a microphone opening protection cover, wherein the protection cover (3) is integrated within the housing and is made out of a woven or non-woven fabric. Within the protection cover a switch or push button knob (9) is arranged.

The present invention refers to a hearing aid housing with a microphone opening protection cover according the preamble of claim 1.

Hearing instruments usually contain at least one microphone for receiving sound from the environment, which is amplified, modified and afterwards transferred to the ear of an user person. The sound from the environment is collected through an opening within the casing, especially at so called behind the ear hearing instruments (BTE) which has to be protected against the entrance of dust or humidity.

Microphone opening protections as well as so called weather protection for hearing instruments are known in the state of the art. E.g. within the DE 10 2007 027 920 a microphone protection for a hearing aid is described as well as within the WO 2007/109517. The use of different protection materials is widely described by usage of woven fibres, membranes, mesh and filtration media. The manufacturing method for producing such opening protections is mainly defined by moulding method, which means is mainly defined by the mechanical characteristic described by the physical shape.

The disadvantages of the current solutions are that the actual solutions are mostly relying on insertion moulding, which is a manual and costly process. E.g. filtration media has to be inserted manually. In addition the actual solutions are not part of the housing shell, it is mostly a replaceable part in the shell. Furthermore, the described solutions do not have other functionalities integrated than the protection of the microphone.

It is therefore an objection of the present invention to provide a microphone protection at which additional functions may be integrated and which is producible in a cost effective and easy manner.

According the present invention a hearing aid housing with a microphone opening protection cover is proposed according the wording of claim 1.

According the present invention it is proposed that the protection cover is integrated within the housing or shell and is comprising a woven or non-woven fabric.

It is further proposed that within the protection cover at least a switch or push button knob is arranged. The integrated switch or push button knob can be molded direct into the microphone protection. As a result, there is no opening to the inner mechanics of the hearing instrument so that the protection will be very good against dust, humidity and other particles selectable by choosing distinct protective media. In addition it is possible that the protection cover is divided into at least two separate parts, of which each one is covering a respective microphone. This is especially the case, when two or more microphones are arranged within the hearing instrument. The microphone protection can be directly integrated in a housing shell or bigger part of the housing shell. This will allow producing a very reliable hearing instrument with a build in protection with very good protection performance. Hence this does not need many assembly steps, parts or manual tasks, this will be preferably for low cost and rugged style of hearing instruments. In efforts towards a water resistant hearing instrument this will be probably a part of the solution. In this case for replacing a clogged or destroyed protection cover, the housing shell has to be exchanged.

In contrast to the mentioned solution, the protection cover can also be a separate part, which will be minimal in size and easily replaceable. The protective media, which means the woven or non-woven fabric, can be enclosed within a frame, which will exactly define the mechanical fit into the hearing instrument housing.

In case that a switch or a push button knob is arranged, this can be directly integrated within the protective cover or a respective section within the cover can be provided with the knob being arranged behind the protective part.

The use of the proposed woven or non-woven fabric is providing necessary chemical properties like oleophobic, hydrophobic behavior as well as acoustical transparency.

According one embodiment it is proposed to use a fabric material made out of PET (Polyethylene terephthalate). Other suitable polymeric material may be used. Further, the fabric may be coated with a hydrophobic and/or oleophobic material.

The invention shall be described by examples and with reference to the attached figures.

In the figures

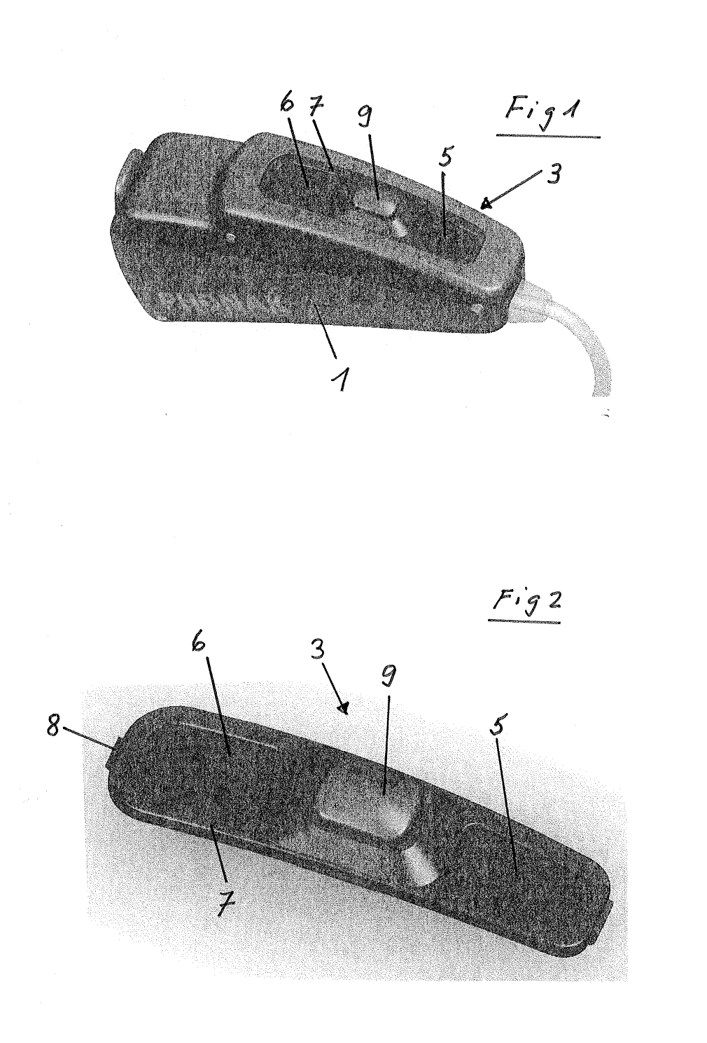

FIG. 1 shows in perspective view a hearing instrument casing with an integrated microphone protection cover, according the present invention,

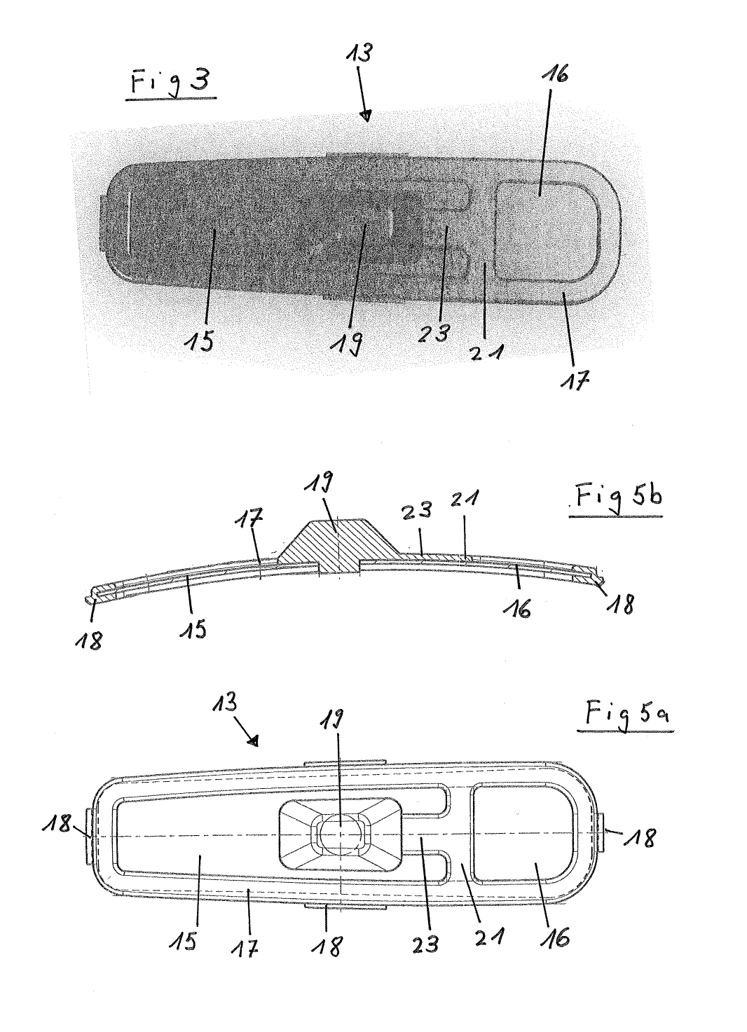

FIG. 2 shows the microphone protection cover in perspective view from FIG. 1,

FIG. 3 shows a further embodiment of the inventive protection cover in top view

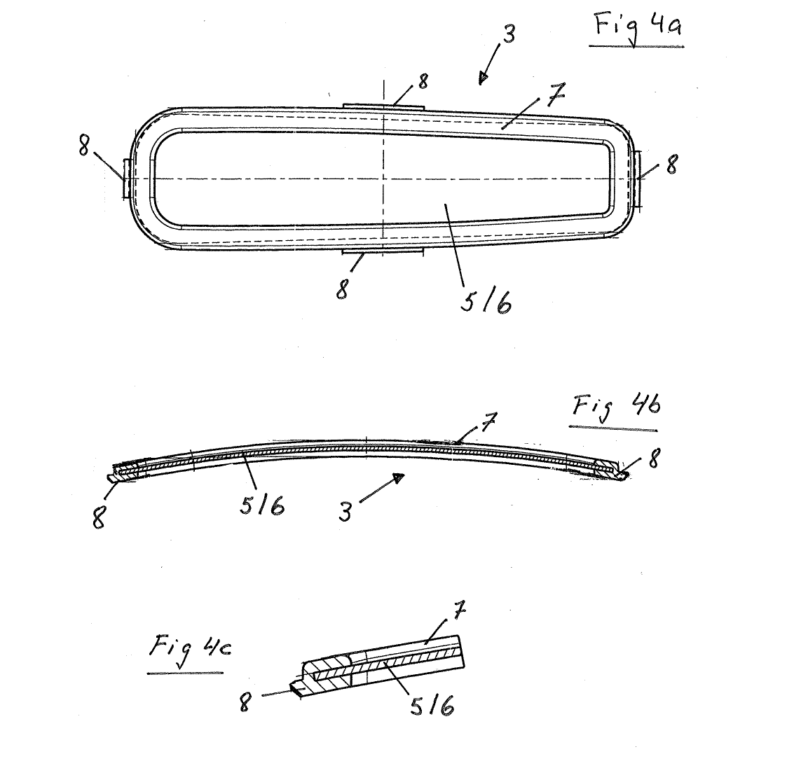

FIGS. 4a, b and c show a simple embodiment of a protection cover in a longitudinal cut, in top view and in a sectional view, and

FIGS. 5 a and b show the embodiment of FIG. 3 schematically in a longitudinal cut and again in a top view.

FIG. 1 shows in perspective view a hearing instrument casing or shell 1, where the microphone opening is protected by a microphone protection cover 3. The protection cover is comprising two separated sections 5 and 6, each one is covering and protecting a respective microphone opening. The two sections 5 and 6 and the cover as such, is enclosed within a frame 7, made out e.g. of a thermoplastic polymer. In the middle between the two sections 5 and 6 a switch or push button knob 9 is arranged.

FIG. 2 shows only the opening protection cover 3 without the hearing aid casing. The two sections 5 and 6 are arranged within a frame 7 made out e.g. of a thermoplastic polymer, such as e.g. a polyamide. Finally between the sections 5 and 6 a push button knob 9 is arranged, which can be made out of an elastomeric polymer so that it has a certain flexibility.

The production of the microphone protection cover 3 can be made with molding technique, which means the frame 7 surrounding the two fabric sections 5 and 7 can be applied by injection molding. If a different polymer is used for producing the push button knob 9, it is also possible to use two different polymers at the same injection molding step.

As visible in FIG. 2 at both ends, so called assembly projecting parts 8 are arranged, to fit the cover into respective receiving parts within the hearing aid housing.

FIG. 3 shows a further embodiment of the inventive microphone protection cover 13, again comprising two sections 15 and 16 each one covering and protecting a respective microphone of the hearing aid. Again the two sections are surrounded by a frame 17. In contrast to the design of FIG. 2 a bar or bridge 21 is arranged, from which a further connecting bar 23 is holding a switch or push button knob 19, which is arranged approximately in the middle of the protection cover. By using the construction according the embodiment of FIG. 3, it is possible that the actuation of the push button knob is not mainly due to an elastomeric material, but due to a certain flexibility of the two bars 21 and 23 so that the push button knob 19 is pivoting around the axis of the bar 21.

For arranging the protective cover into an hearing instrument casing there are in principal two possibilities. One possibility is that the woven or non-woven fabric used for the protection cover is directly integrated into the casing when it is produced e.g. by injection molding. The other possibility is to produce the cover as an independent part as e.g. shown schematically with reference to FIGS. 4a to 4c.

FIG. 4a shows the protection cover 3 without a switch or knob and with the two sections 5 and 6 forming one single opening protection.

For the arrangement of the protection cover, at both ends and also from the two sides, projecting blades or lamellas are arranged, which is best seen in FIG. 4c, where a sectional view of one end of the protection cover is shown. By means of the e.g. four blades or lamellas 8 the protection cover can be inserted into a respective opening within the hearing instrument casing, where respective receptacle recesses or slots are arranged.

FIGS. 5a and 5b finally again show the embodiment of FIG. 3 in longitudinal cut view and in top view.

FIG. 5a shows in top view an inventive microphone opening cover 13, comprising two sections 15 and 16 made preferably out of a woven or non-woven fabric made with a PET material. Such fabric material made out of PET are known, such as e.g. the Sefar Petex filter material from Sefar AG made of woven fabrics, whereas material PET is used. The fabric material for the two sections 15 and 16 is surrounded by a frame 17, made out of a thermoplastic material such as e.g. polyamide. Furthermore, as seen in FIG. 5a an interconnecting bar 21 is connecting the two length wise extending frame parts, from which further an additional bar 23 is protecting towards the centre of the protection cover, where a push button knob 19 is arranged. This push button knob 19 can be either made out of an elastomeric polymer in case that the respective push button for switching purpose is integrated within the part 19. Due to the used construction as shown in FIGS. 5a and 5b, this push button knob 19 can also be made out of a thermoplastic polymer, such as the above mentioned polyamide, as due to the projecting bar 23 a pivoting movement around the axis of the connecting bar 21 towards the interior of the hearing instrument is possible so that a push button knob or switch arranged beneath the part 19 can be actuated.

Further visible in either FIG. 5a as well as in FIG. 5b are the lamellas or projections 18 provided for the insertable engagement of the protection cover into a respective opening of the hearing instrument casing.

The examples as shown in FIGS. 1 to 5 are mainly shown for the better understanding of the present invention. By no means the invention is restricted to the shown examples, as they can be modified or amended by further parts in any manner. Also the mentioned materials are examples, which can be changed due to the required characteristics of the protective cover.

The proposed inventive microphone protection cover represents very reliable solutions towards environmental reliability. Appearance towards the end user is adaptable and matches better than existing solutions. The proposed cover does allow very small hearing aid instrument casings with optimum use of space. The production of the cover is less complex in production processes of hearing instrument devices, which has an influence on costs and conductibility in terms of acoustical stability in the field.

1. Hearing aid housing with a microphone opening protection cover, characterized in that the protection cover (3,13) is integrated within the housing and is made out of a woven or non-woven fabric and in that a switch or push button knob (9,19) is arranged within the protection cover (3,13).

2. Hearing aid housing according claim 1, characterized in that approximately in the middle of the protection cover a portion for the arrangement of a switch or push button knob is arranged.

3. Hearing aid housing according claim 1 or 2, characterized in that the fabric of the protection is at least partially surrounded by a thermoplastic polymer material, which is compatible with PET.

4. Hearing aid housing according claim 3, characterized in that the thermoplastic polymer material is a polyamide material.

5. Hearing aid housing according one of the claims 1 to 4 characterized in that the fabric is made out of a PET material (Polyethylene terephthalate).

6. Hearing aid housing according one of the claims 1 to 5, characterized in that the protection cover comprises at least two sectional areas (5,6,15,16) each one provided to cover a respective microphone, between the sectional areas a bar-like bridging portion (21) is arranged for interconnecting the frame (17) surrounding the woven or non-woven fabric material.

7. Hearing aid housing according claim 1, characterized in that from the bar-like bridge in longitudinal direction a further bar portion (23) is projecting and connecting the bar-like bridge (21) with a switch or push button knob (19) in such a manner that the switch or push button knob is at least slightly pivotable moveable around the axis through the bar-like bridge connection.

8. Hearing aid housing according one of the claims 1 to 7, characterized in that the microphone protection cover is hold by lamellas or projecting portions projecting out of the frame, surrounding the woven or non-woven fabric.

9. Hearing aid housing according one of the claims 1 to 8, characterized in that the protection cover is coated with a hydrophobic and/or an oleophobic material.
